(19) United States
(12) Patent Application Publication
(10) Pub. No.: US 2009/0304365 A1
(43) Pub. Date: Dec. 10, 2009

(54) METHODS AND APPARATUSES FOR USE WITH A DATA ACCESS DEVICE AND AN OPTICAL DISC IN AN ELECTRONIC ENTERTAINMENT SYSTEM

(75) Inventors: Kyle Prestenback, Burbank, CA (US); Evan Tahler, Burbank, CA (US); Brian Kwan, Pasadena, CA (US); Evan Acosta, La Crescenta, CA (US)

Correspondence Address: DISNEY ENTERPRISES, INC;C/O BERKELEY LAW & TECHNOLOGY GROUP, LLP, 17933 NW Evergreen Parkway, Suite 250, BEAVERTON, OR, 97006, US

(73) Assignee: DISNEY ENTERPRISES, INC., Burbank, CA (US)

(21) Appl. No.: 12/238,335

(22) Filed: Sep. 25, 2008

Related U.S. Application Data
(60) Provisional application No. 61/059,552, filed on Jun. 6, 2008.

(51) Int. Cl. H04N 5/00

(52) U.S. Cl. 386/126; 386/E05.001

(57) ABSTRACT

Methods and apparatuses are provided, which may be implemented using an optical disc and a data access device such as, e.g., an optical disc player device. The optical disc may include content information, such as, video data, audio data, and advertisement data. The advertisement data may be associated with at least one product and/or service that is not adapted for use by the optical disc player device. The optical disc may include instructional information to adapt the optical disc player device to access user input data identifying user contact information and at least one advertisement selection, and to initiate transmission of an information request associated with at least one product and/or service associated with advertisement selection and/or advertisement data. The information request may include user contact information and may be adapted for use by at least one information delivery system which may initiate subsequent user contact without using the optical disc player device.

### RELATED APPLICATIONS

This patent application claims benefit of and priority to U.S. Provisional Patent Application 61/059,552, filed Jun. 6, 2008, and titled “Methods And Apparatuses For Use With An Optical Disc Player Device In An electronic Entertainment System”, and which is incorporated in its entirety by reference herein.

### BACKGROUND

1. Field

The subject matter disclosed herein relates to electronic devices, and more particularly to methods and apparatuses for use with an optical disc and/or data access device such as, e.g., an optical disc player device.

2. Information

Electronic entertainment systems and the like continue to advance in sophistication and popularity. Standard definition televisions are being replaced with higher definition video monitor devices and high fidelity audio monitor devices in an attempt to provide an improved entertainment experience. Likewise, standard definition video tape players and/or DVD player devices are being replaced with higher definition optical disc player devices, such as, for example, Blu-Ray disc player devices.

Computing and communication systems and networks also continue to advance in sophistication and popularity. The Internet and related computing and communication infrastructure, for example, continues to improve and expand in content, access, speed, variety, etc. Electronic entertainment systems may be further enhanced by interfacing with such networked resources. By way of example, certain set-top boxes may be adapted to access networked resources and provide information and/or content received there from for use in an electronic entertainment system. Some set-top boxes may also be adapted to allow for information and/or content to be provided from one or more devices in an electronic entertainment system to one or more networked resources.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating an exemplary implementation of an electronic entertainment environment that includes a data source such as an optical disc and a data source access device such as an optical disc player device.

FIG. 2 is a block diagram illustrating an exemplary implementation of a data source such as an optical disc and a data source access device such as an optical disc player device as may be implemented for use in an electronic entertainment environment, for example, as in FIG. 1.

FIG. 3 is a flow diagram illustrating an exemplary implementation of a method that be adapted for use in or with a data source such as an optical disc and/or a data source access device such as an optical disc player device within an electronic entertainment environment, for example, as in FIG. 1 and/or FIG. 2.

### DETAILED DESCRIPTION

In accordance with an aspect of an exemplary implementation, a data source such as an optical disc (for example, a Blu-Ray disc, etc.), may include content information and instructional information, which may be read by a data source access device such as an optical disc player device, and which may adapt a data source access device, at least in part, to at least initiate presentation of content that is associated with one or more products and/or services that may be of interest to the user. For example, content may be presented to a user in some manner through at least a portion of an electronic entertainment environment.

In certain implementations, such instructional information may, for example, adapt an optical disc player device and/or the like to permit the user to selectively request, or at least initiate a request for, information regarding such products and/or services, etc. Here, for example, one or more devices may be adapted to transmit an information request in at least one message over a network to at least one network resource device. Such network resource device(s) may be adapted to at least initiate in some manner a “subsequent user contact”. For example, subsequent user contact may occur through an electronic communication and/or telephonic communication to another device or devices that may be associated with and/or otherwise accessible in some manner by a user and/or some person or entity associated with the user. In certain implementations, such network resource device or devices may be adapted to at least initiate subsequent user contact, for example, through a postal communication addressed to the user.

With the methods and apparatuses provided herein, a data source access device such as an optical disc player device may only need to be adapted to access a network (e.g. the Internet), in a limited manner, rather than being adapted to provide a full browser or other like more interactive and possibly complicated computer-like application. Thus, with the methods and apparatuses provided herein, an optical disc may be adapted to provide the content regarding certain products/services that may be presented to the user and may further provide computer implementable instructions associated therewith to adapt the optical disc player device to receive and/or otherwise access user input (e.g., associated with the user's interest or lack of interest in such products/services), and at least initiate communication of an information request, when applicable, to one or more information delivery systems.

Consequently, in certain exemplary implementations, a data source access device such as an optical disc player device may not need to be adapted to download content information and/or instructional information from the Internet to provide an enhanced interactive user experience. Instead, such device may only need to be adapted to transmit and/or at least initiate transmission of one or more messages over a network.

With such capabilities and the like in mind, those skilled in the art will come to recognize upon reading this description that in certain implementations, subject matter as claimed herein may reduce the cost and/or complexity of certain data source access devices such as, e.g., an optical disc player device.

In certain implementations, subject matter claimed herein may allow for a more controlled and/or a richer user experience by allowing for the content information and operative instructional information to be specifically tailored or otherwise adapted possibly providing for a seamless and/or otherwise more cohesive user experience with regard to a data source such an optical disc.

In certain implementations, subject matter claimed herein may allow for a more controlled and/or a richer user experience by allowing for the content information and/or operative instructional information to possibly be up-to-date, more easily updated, and/or otherwise maintained when compared to a built-in browser or other like application in a device.

In certain implementations, subject matter claimed herein may allow for a possibly more controlled and/or predictable user experience across different optical disc player device platforms.

In certain implementations, subject matter claimed herein may allow for a reduction in number, type, and/or complexity of devices within an electronic entertainment system. For example, an optical disc player device may be adapted to possibly provide an enhanced interactive user experience without the need for an additional set-top box and/or other like separate network-ready device.

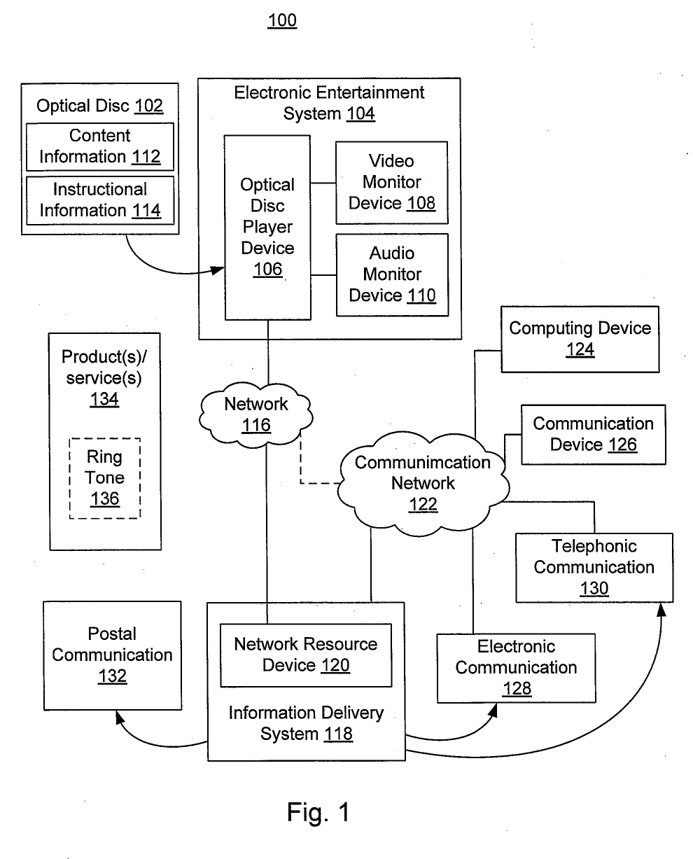

With these and other potential aspects in mind, attention is drawn to FIG. 1, which is a block diagram illustrating an example electronic entertainment environment 100. As shown, environment 100 may include a data source access device such as an optical disc 102 adapted for use in an electronic entertainment system 104. System 104 may include an optical disc player device 106 coupled to a video monitor device 108 and an audio monitor device 110. In this example, optical disc 102 may include content information 112 and/or instructional information 114.

Electronic entertainment system 104 may, for example, be operatively coupled to communicate with at least one information delivery system 118 through at least one network 116 and/or the like. As shown in this example, information delivery system 118 may include and/or otherwise be operatively associated with at least one network resource device 120.

In certain exemplary implementations, optical disc player device 106 may be adapted to transmit at least one information request through network 116 to network resource 120. Such information request may, for example, be associated with one or more products/services 134. Here, for example, at least a portion of content information 112 (e.g., advertisement information, or the like) that may be stored at least in part on optical disc 102 may be associated with such products/services 134.

Visual and/or audio reproduction associated with such advertisement information or the like may, for example, be presented to a user of system 104 in such a manner that the user may selectively initiate a request for additional information associated with products/services 134. For example, advertisement information may be provided together with and/or separately from other content information.

At least a portion of instructional information 114 may be implemented to adapt optical disc player device 106 to allow for such a selection through user input and to generate an associated information request.

Information delivery system 118 may, for example, be adapted to respond to such an information request by initiating and/or otherwise providing additional information associated with one or more products/services 134, and/or possibly even a portion of such products/services, to the user and/or another device associated with the user. For example, in certain implementations, an information request may include an electronic address (e.g., an electronic mail address, a URL, etc.) associated with the user, and information delivery system 118 may be adapted to send an electronic communication 128 using the electronic address. Here, for example, the user may receive or otherwise access electronic communication 128 through a computing device 124 that may be coupled to information delivery system 118 through a communication network 122.

In another example implementation, an information request may include a telephonic number (e.g., cell phone number, land-line number, facsimile number, etc.) associated with the user and information delivery system 118 may be adapted to send a telephonic communication 130 using the telephonic number. Here, for example, the user may receive or otherwise access telephonic communication 130 through a communication device 126 that may be coupled to information delivery system 118 through communication network 122.

In yet another example implementation, an information request may include a postal address (e.g., post office box, street address, etc.) associated with the user and information delivery system 118 may be adapted to send a postal communication 132 to the postal address. Here, for example, the user may receive postal communication 132 through a postal system or other like parcel delivery system/service.

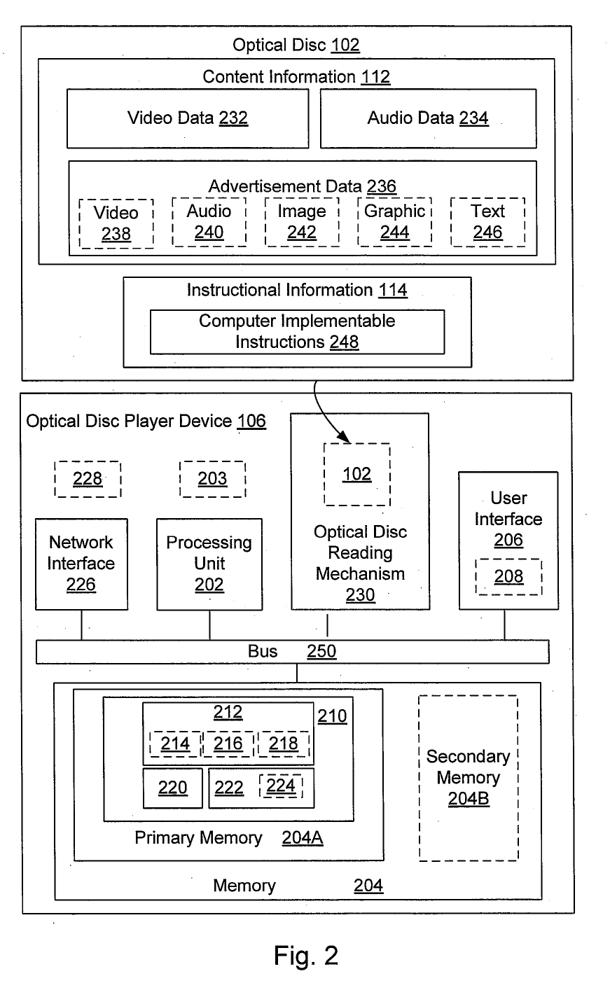

Attention is drawn next to FIG. 2, which is a block diagram illustrating certain example features that may be implemented in an exemplary optical disc 102 and/or an exemplary optical disc player device 106.

Optical disc player device 106 may, for example, include at least one processing unit 202, some form of memory 204, at least one user interface 206, an optical disc reading mechanism 230, and a network interface 226. As illustrated in FIG. 2, at least one bus 250 or the like may be adapted to operatively couple two or more of processing unit 202, memory 204, user interface 206, optical disc reading mechanism 230, and/or network interface 226.

As illustrated, optical disc 102 may be operatively coupled to (and accessed through) optical disc reading mechanism 230. Optical disc 102 may have stored thereon content information 112, including video data 232, audio data 234, and advertisement data 236. In certain implementations, for example, advertisement data 236 may be associated with at least one product and/or service that is not adapted for use by the optical disc player device. Advertisement data 236 may, for example, include advertisement video data 238, advertisement audio data 240, advertisement image data 242, advertisement graphic data 244, and/or advertisement textual data 246.

Optical disc 102 may, for example, have stored thereon instructional information 114 including computer implementable instructions 248.

Memory 204 may, for example, include primary memory 204A. In certain example implementations memory 204 may also include secondary memory 204B (e.g., a hard disk drive, solid state drive, or other like non-volatile storage devices and/or media).

As shown in FIG. 2, primary memory 204A may include user input data 210 associated with user input that may be received through user interface 206. In certain implementations, user input may be received by user interface 206 and corresponding user input data 210 provided to memory 204 from user interface 206, for example, through bus 250. In certain implementations, user input may be received by user interface 206 and provided to processing unit 202, which may provide corresponding user input data 210 to memory 204, for example, through bus 250.

By way of example but not limitation, user interface 206 may include and/or otherwise be operatively coupled to a user input device 208 (e.g., a keypad, a touch screen, a joystick, a mouse, remote control, a camera, a microphone, etc.) that may be adapted to register and/or otherwise accept user input and relay such to user interface 206. In certain exemplary implementations, user interface 206 may include a wireless communication interface adapted to receive wireless signals (not shown) from a remotely controlled user input device 208. Such wireless signals may, for example, include infrared, radio frequency, or other like electromagnetic signals.

As illustrated in the example implementation in FIG. 2, user input data 210 may include user contact information 212 and at least one advertisement selection 220. Here, for example, user contact information 212 may include data that in some manner identifies and/or may be otherwise associated with a user. By way of example but not limitation, user contact information 212 may include an electronic communication address 214, a telephonic communication number 216, a postal communication address 218, and/or the like.

Advertisement selection 220 may include data that may in some manner identify and/or otherwise represent a user's interest or possible lack of interest in one or more products/services to which at least a portion of advertisement data 236 may be directed and/or otherwise associated with. By way of example but not limitation, at least a portion of advertisement data 236 may be associated with a product, such as a ring tone 136 (see FIG. 1) for a cellular telephone and/or like device (not shown). Here, optical disc player device 106 may be adapted to present content information about the ring tone through video and/or audio monitors in a manner that invites and/or otherwise permits the user to selectively indicate their interest or possible lack of interest in possibly requesting (as applicable) more information.

For example, a user may indicate an interest in receiving more information regarding a product's cost, specifications, options, etc. Here, for example, a user may indicate an interest in receiving more information regarding a product by submitting a purchase order, accepting an offer, etc. Thus, for example, a user may provide user input that indicates an interest in receiving ring tone 136 and such interest may be represented by advertisement selection 220.

Those skilled in the art will recognize that there are many different ways to implement such a user input based decision and selection process. By way of example but not limitation, advertisement selection 220 may include an item identifier (not shown) associated with the products/services and/or at least a portion of advertisement data that may or may not be of interest, and/or a flag value (not shown) indicative of the user's interest or possible lack of interest. Advertisement selection 220 may therefore include data related to the user's actual indicated interest or possible lack of interest with regard to the products/services and/or at least a portion of advertisement data.

In certain implementations, advertisement selection 220 may, for example, include data representative of a perceived user's interest or perceived lack of interest with regard to the products/services and/or at least a portion of advertisement data. For example, a user may passively indicate an interest or possible lack of interest with regard to the products/services and/or at least a portion of advertisement data by not actively making a user input selection. Indeed, in certain example implementations, a user may input user preference data 222 to establish preferences and/or policies associated with an interest or possible lack of interest with regard to all or certain products/services and/or all or portions of advertisement data 236. Such preference data 222 may, for example, be pre-established, periodically updated, persisted, associated with a specific user or group of users, related to parental/content ratings or other like content/device security settings, etc.

In certain example implementations, preference data 22 may include at least one preference parameter 224. Preference parameter 224 may, for example, represent a user's preference regarding all or part of a process for requesting information about products/services, all or part of a process for receiving such requested information, and/or all or part of a process for presenting or otherwise handling at least a portion of advertisement data 236. By way of example but not limitation, preference parameter 224 may be adapted to allow a user to “opt-in” or “opt-out” of one or more processes for requesting information about products/services, and/or one or more processes for presenting or otherwise handling at least a portion of advertisement data 236.

While not shown in FIG. 2, optical disc reading mechanism 230 may, for example, include a receptacle adapted for receiving optical disc 102, an optical disc rotation mechanism adapted for rotating optical disc 102, a optical reading mechanism (e.g., a laser read head, etc.) adapted for reading information stored on optical disc 102 in the form of data, and supporting control circuitry adapted for controlling the operation of optical disc reading mechanism 230 and providing the information read from optical disc 102 to at least bus 250.

In certain exemplary implementations, optical disc reading mechanism 230 may be adapted to read one or more of a compact disc (CD), a digital versatile disc (DVD), a Blu-Ray disc, and/or the like. In certain exemplary implementations, optical disc reading mechanism 230 may be adapted to hold and/or otherwise manipulate multiple optical discs. In certain exemplary implementations, optical disc 102 may be adapted as a read-only disc, a read/writable disc, a read/rewritable disc, etc. Thus, in certain implementations, optical disc reading mechanism 230 may be adapted to only read from optical disc 102, while in other implementations optical disc reading mechanism 230 may be adapted to read and write to optical disc 102. Such mechanisms and techniques are well known.

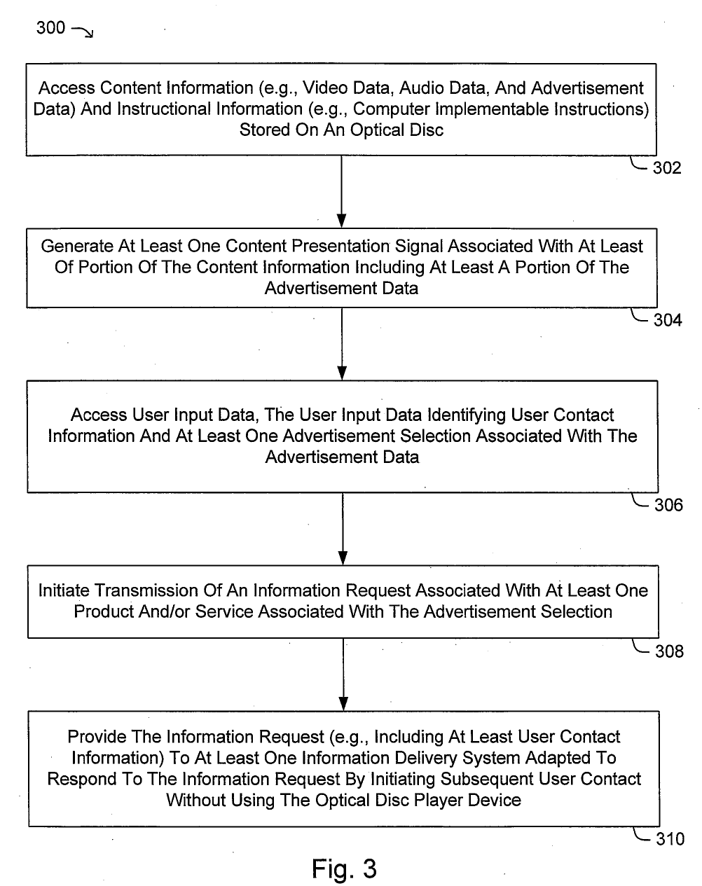

Processing unit 202 may, for example, be implemented using hardware, firmware, software, and/or any combination thereof. Processing unit 202 may, for example, be implemented using digital and/or analog circuitry. Processing unit 202 may, for example, be implemented using a central processing unit, a microprocessor, a microcontroller, an application specific integrated circuit (ASIC), a graphical processing unit (GPU), and/or other like circuits. Processing unit 202 may include any form of circuitry that may be adapted based, at least in part, on at least a portion of instructional information 114. Processing unit 202 may, for example, be adapted to perform and/or to otherwise support at least a portion of exemplary method 300 shown in FIG. 3.

By way of example but not limitation, one or more processing units 202 may be adapted to access and/or to otherwise support accessing content information stored on optical disc 102 and/or in memory 204, and/or generate and/or to otherwise support generation of at least one content presentation signal 203 associated with at least of portion of such content information. Here, for example, such content presentation signal 203 may be adapted for use by video monitor device 108 and/or audio monitor device 110.

By way of example but not limitation, one or more processing units 202 may be adapted to access and/or to otherwise support accessing instructional information 114 stored on optical disc 102 and/or in memory 204. Such instructional information may, for example, include computer implementable instructions 248 that may further adapt one or more processing units 202 to access and/or to otherwise support accessing user input data 210, which may include user contact information 212 and/or at least one advertisement selection 220. Such instructional information may, for example, include computer implementable instructions 248 that may further adapt one or more processing units 202 to initiate and/or to otherwise support initiation of the transmission of at least one information request 228. In certain implementations, such instructional information may, for example, include computer implementable instructions 248 that may further adapt one or more processing units 202 to initiate and/or to otherwise support initiation of transmission of information request 228 based, at least in part, on at least one preference parameter 224 and/or the like.

By way of example but not limitation, information request 228 may be implemented using one or more messages which may include and/or otherwise be associated with at least a portion of user contact information 212. At least a portion of such information request 228 may, for example, be adapted for transmission by network interface 226 through network 116 to at least one network resource device 120 that may be operatively associated with at least one information delivery system 118. In certain implementations, information request 228 may be implemented using one or more messages which may include and/or otherwise be associated with at least a portion of advertisement selection 220. For example, such information request 228 may be adapted for transmission to a specific network resource device 120 based, at least in part, on advertisement selection 220.

Network interface 226 may, for example, include any circuitry adapted to provide for communication with at least network 116. Network interface 226 may, for example, be adapted to provide such communication over one or more wired and/or wireless communication links. Network 116 may, for example, include one or more communication resources adapted to provide communication between network interface 226 and at least one network resource device 120. By way of example but not limitation, in certain implementations, network 116 may include a wired and/or wireless local area network (LAN and/or WLAN), a wired and/or wireless telephone network, the Internet, and/or the like. By way of example but not limitation, in certain implementations, network interface 226 may include a wired and/or wireless modem, an Ethernet interface, a telephone interface, an antenna, a transmitter, a receiver, a transceiver, and/or the like.

While in certain implementations network 116 and communication network 122 may be the same and/or otherwise share certain resources, in other implementations network 116 and communication network 122 may be separate networks. For example, network 116 may include the Internet and communication system 122 may include a wireless telephone network. Here, for example, information request 228 may be associated with ring tone 136 and provided to network resource device 120 (e.g., a server, etc.) via the Internet, and network resource device 120 may respond by initiating an electronic communication 128 and/or telephonic communication 130 through a wireless telephone network to communication device 126 and/or computing device 124.

Network resource device 120 may include any device and/or devices adapted to receive information request 228. In certain example implementations, network resource device 120 may be adapted to respond and/or otherwise support a response by information delivery system 118 to information request 120 by at least initiating subsequent user contact without using the optical disc player device.

Reference is now made to FIG. 3, which is a flow diagram illustrating an exemplary method 300 that may be implemented in whole or in part in environment 100 and/or a data access device such as, e.g., optical disc player device 106.

At block 302, content information (e.g., video data, audio data, and advertisement data) and instructional information (e.g., computer implementable instructions) stored on an optical disc may be accessed. Block 302 may include copying at least a portion of content information and/or instructional information to memory.

At block 304, at least one content presentation signal may be generated. The content presentation signal may be associated with at least of portion of the content information including at least a portion of the advertisement data.

At block 306, user input data may be accessed. Here, for example, the user input data may be accessed from memory and identify and/or otherwise be associated with user contact information and at least one advertisement selection associated with the advertisement data.

At block 308, transmission of an information request may be initiated. The information request may, for example, be associated with at least one product and/or service. In certain exemplary implementations, the product/service may be associated with the advertisement selection.

At block 310, the information request (e.g., including at least user contact information) may be provided to at least one information delivery system. Here, for example, the information delivery system may be adapted to respond to the information request by initiating subsequent user contact without using the optical disc player device. Such user contact may include products/services, textual information, graphics, images, audio, video, links to websites, programs, applications, games, text messages, electronic mail, instant messages, letters, etc.

While certain exemplary techniques have been described and shown herein using various systems and methods, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
with a data access device, accessing content information stored on an optical disc said content information comprising video data, audio data, and advertisement data, said advertisement data being associated with at least one product and/or service that is not adapted for use by the data access device, said advertisement data comprising at least one of advertisement video data, advertisement audio data, advertisement image data, advertisement graphic data, and/or advertisement textual data;
generating at least one content presentation signal associated with at least of portion of said content information comprising at least a portion of said advertisement data, said at least one content presentation signal being adapted for use by at least one of a video monitor device and/or an audio monitor device;
accessing instructional information stored on said optical disc, said instructional information comprising computer implementable instructions; and
based, at least in part, on said instructional information, adapting one or more processing units within said data access device to:
access user input data, said user input data identifying user contact information and at least one advertisement selection associated with said advertisement data, and
initiate transmission of an information request, said information request being associated with said at least one product and/or service based, at least in part, on said at least one advertisement selection, said information request comprising at least said user contact information and being adapted for use by at least one information delivery system that is adapted to respond to said information request by initiating subsequent user contact without using the data access device.

2. The method as recited in claim 1, wherein the data access device comprises an optical disc player device.

3. The method as recited in claim 1, wherein said at least one information delivery system is adapted to respond to said information request by initiating user contact through at least one network and at least one of a computing device and/or a communication device operatively coupled to said at least one network.

4. The method as recited in claim 1, wherein said at least one information delivery system is adapted to respond to said information request by initiating user contact via at least one of an electronic communication, a telephonic communication, and/or a postal communication.

5. The method as recited in claim 3, wherein at least one of said electronic communication, said telephonic communication, and/or said postal communication is adapted to deliver at least a portion of said product and/or service.

6. The method as recited in claim 1, wherein said user contact information comprises at least one of an electronic communication address, a telephonic communication number, and/or a postal communication address.

7. The method as recited in claim 1, wherein said optical disc comprises a Blu-Ray optical disc.

8. The method as recited in claim 1, wherein:
said user input data further comprises user input preference data identifying at least one preference parameter; and
adapting said one or more processing units within said data access device to initiate transmission of said information request further comprises selectively initiating transmission of said information request based, at least in part, on said at least one preference parameter.

9. The method as recited in claim 1, wherein said at least one product and/or service is associated with at least a portion of at least one of said video data and/or said audio data.

10. The method as recited in claim 1, wherein said at least one product and/or service comprises a ring tone.

11. An optical disc player device adapted for use in an entertainment system having a video monitor device and an audio monitor device, the optical disc player device comprising:
means for accessing information stored on an optical disc, said information comprising instructional information and content information, said content information comprising video data, audio data, and advertisement data, said advertisement data being associated with at least one product and/or service that is not adapted for use by the optical disc player device, said advertisement data comprising at least one of advertisement video data, advertisement audio data, advertisement image data, advertisement graphic data, and/or advertisement textual data;
means for generating at least one content presentation signal associated with at least of portion of said content information comprising at least a portion of said advertisement data, said at least one content presentation signal being adapted for use by at least one of said video and/or audio monitor devices; and
wherein said instructional information comprises means for adapting one or more processing units within said optical disc player device to access user input data, said user input data identifying user contact information and at least one advertisement selection associated with said advertisement data, and initiate transmission of an information request, said information request being associated with said at least one product and/or service based, at least in part, on said at least one advertisement selection, said information request comprising at least said user contact information and being adapted for use by at least one information delivery system that is adapted to respond to said information request by initiating subsequent user contact without using the optical disc player device.

12. The optical disc player device as recited in claim 11, wherein said at least one information delivery system is adapted to respond to said information request by initiating user contact through at least one network and at least one of a computing device and/or a communication device operatively coupled to said at least one network.

13. The optical disc player device as recited in claim 11, wherein said at least one information delivery system is adapted to respond to said information request by initiating user contact via at least one of an electronic communication, a telephonic communication, and/or a postal communication.

14. The optical disc player device as recited in claim 13, wherein at least one of said electronic communication, said telephonic communication, and/or said postal communication is adapted to deliver at least a portion of said product and/or service.

15. The optical disc player device as recited in claim 11, wherein said user contact information comprises at least one of an electronic communication address, a telephonic communication number, and/or a postal communication address.

16. The optical disc player device as recited in claim 11, wherein said optical disc comprises a Blu-Ray optical disc.

17. The optical disc player device as recited in claim 11, wherein:
said user input data further comprises user input preference data identifying at least one preference parameter; and
said means for adapting said one or more processing units within said optical disc player device to initiate transmission of said information request is adapted to selectively initiate transmission of said information request based, at least in part, on said at least one preference parameter.

18. The optical disc player device as recited in claim 11, wherein said at least one product and/or service is associated with at least a portion of at least one of said video data and/or said audio data.

19. The optical disc player device as recited in claim 11, wherein said at least one product and/or service comprises a ring tone.

20. An optical disc player device adapted for use in an entertainment system having a video monitor device and an audio monitor device, the optical disc player device comprising:
an optical disc having information stored thereon, said information comprising instructional information and content information, said content information comprising video data, audio data, and advertisement data, said advertisement data being associated with at least one product and/or service that is not adapted for use by the optical disc player device, said advertisement data comprising at least one of advertisement video data, advertisement audio data, advertisement image data, advertisement graphic data, and/or advertisement textual data;
an optical disc reading mechanism adapted to access said information from said optical disc;
memory operatively coupled to said optical disc reading mechanism and adapted to store at least a portion of said accessed information;
a user interface adapted to receive user input and provide corresponding user input data;
a network interface adapted to connect said optical disc player device to at least one communication network;
at least one processor operatively coupled to at least one of said memory, said user interface, and/or said network interface and adapted to:
generate at least one content presentation signal associated with at least of portion of said content information comprising at least a portion of said advertisement data, said at least one content presentation signal being adapted for use by at least one of said video and/or audio monitor devices; and
based, at least in part, on said instructional information:
access said user input data, said user input data identifying user contact information and at least one advertisement selection associated with said advertisement data, and
initiate transmission of an information request through said network interface, said information request being associated with said at least one product and/or service based, at least in part, on said at least one advertisement selection, said information request comprising at least said user contact information and being adapted for use by at least one information delivery system that is adapted to respond to said information request by initiating subsequent user contact without using the optical disc player device.

21. The optical disc player device as recited in claim 20, wherein said user contact information comprises at least one of an electronic communication address, a telephonic communication number, and/or a postal communication address.

22. The optical disc player device as recited in claim 20, wherein said optical disc comprises a Blu-Ray optical disc.

23. The optical disc player device as recited in claim 20, wherein:
said user input data further comprises user input preference data identifying at least one preference parameter; and
based, at least in part, on said instructional information said at least one processing unit is adapted to selectively initiate transmission of said information request based, at least in part, on said at least one preference parameter.

24. The optical disc player device as recited in claim 20, wherein said at least one product and/or service is associated with at least a portion of at least one of said video data and/or said, audio data.

25. The optical disc player device as recited in claim 20, wherein said at least one product and/or service comprises a ring tone.

26. An optical disc adapted for use by an optical disc player device, the optical disc having information stored thereon, said information comprising:
content information comprising video data, audio data, and advertisement data, said advertisement data being associated with at least one product and/or service that is not adapted for use by the optical disc player device, said advertisement data comprising at least one of advertisement video data, advertisement audio data, advertisement image data, advertisement graphic data, and/or advertisement textual data; and
instructional information comprising computer implementable instructions which if implemented by one or more processing units adapt said one or more processing units to:
access user input data, said user input data identifying user contact information and at least one advertisement selection associated with said advertisement data, said user input data being associated with a presentation of said advertisement data, and
initiate transmission of an information request associated with said at least one product and/or service based, at least in part, on said at least one advertisement selection, said information request comprising at least said user contact information and being adapted for use by at least one information delivery system that is adapted to respond to said information request by initiating subsequent user contact without using the optical disc player device.

27. The optical disc as recited in claim 26, wherein said user contact information comprises at least one of an electronic communication address, a telephonic communication number, and/or a postal communication address.

28. The optical disc as recited in claim 26, wherein said optical disc comprises a Blu-Ray optical disc.

29. The optical disc as recited in claim 26, wherein:
said user input data further comprises user input preference data identifying at least one preference parameter; and
said computer implementable instructions which if implemented by said one or more processing units adapt said one or more processing units to selectively initiate transmission of said information request based, at least in part, on said at least one preference parameter.

30. The optical disc as recited in claim 26, wherein said at least one product and/or service is associated with at least a portion of at least one of said video data and/or said audio data.

31. The optical disc as recited in claim 26, wherein said at least one product and/or service comprises a ring tone.
